(19) United States
(12) Patent Application Publication
(10) Pub. No.: US 2017/0085887 A1
(43) Pub. Date: Mar. 23, 2017

(54) METHOD, APPARATUS AND SYSTEM FOR DISPLAYING VIDEO DATA

(71) Applicant: CANON KABUSHIKI KAISHA, Tokyo (JP)

(72) Inventors: CHRISTOPHER JAMES ROSEWARNE, Concord West (AU); JONATHAN GAN, Ryde (AU); VOLODYMYR KOLESNIKOV, Dee Why (AU)

(21) Appl. No.: 15/265,629

(22) Filed: Sep. 14, 2016

(30) Foreign Application Priority Data
Sep. 17, 2015 (AU) 2015227469

(51) Int. Cl. H04N 19/16; H04N 19/184; H04N 19/186; H04N 19/103

(52) U.S. Cl. CPC H04N 19/16; H04N 19/103; H04N 19/184; H04N 19/186

(57) ABSTRACT

A plurality of display device profiles is decoded from a bitstream containing video data. A display device profile is selected by comparing at least a portion of the device information of the display device profiles with corresponding device information of the first display device. An image modification parameter set is selected from a plurality of image modification parameter sets according to the selected display device profile, the plurality of image modification parameter sets being decoded from the bitstream and each of the plurality of image modification parameter sets providing information regarding luminance mapping to be applied to one or more portions of the video data. At least a portion of the video data is displayed on the first display device from the bitstream of video data by applying the selected image modification parameter set to the portion of video data from the bitstream of video data.

### REFERENCE TO RELATED PATENT APPLICATION

This application claims the benefit under 35 U.S.C. §119 of the filing date of Australian Patent Application No. 2015227469, filed Sep. 17, 2015, hereby incorporated by reference in its entirety as if fully set forth herein.

### TECHNICAL FIELD

The present invention relates generally to delivery of video to displays such as televisions, personal computer monitors, displays of portable devices, digital cinema displays and the like. The present invention also relates in particular to a method, apparatus and system for displaying video data on a display device. The present invention also relates to a computer program product including a computer readable medium having recorded there on a computer program for displaying video data on a display device.

### BACKGROUND

The dynamic range of a display device is a ratio between the smallest and the largest possible luminance that the display can reproduce. Contemporary displays such as televisions and computer monitors support displaying content with a high dynamic range (HDR). Such displays have a peak luminance significantly higher than displays supporting only standard dynamic range (SDR). Often, high dynamic range (HDR) displays have colour gamut wider than colour gamut of a standard dynamic range (SDR) display.

The gamut of a display device is the set of all colours that the display device can reproduce. As the majority of display devices are driven by three primary colour sources, the associated gamut is a triangle with vertices corresponding to the primary colour sources (or ‘primaries’). A display device with colour primaries that are more saturated than the colour primaries of SDR displays may be termed a wide colour gamut (WCG) display.

Together, the dynamic range and colour gamut of a display device determine an overall colour volume of the display device. Often, high dynamic range (HDR) displays also offer a wide colour gamut (WCG). Traditional cathode ray tube (CRT) displays typically have a dynamic range of one to three hundred (1:300) and peak luminance of about one hundred (100) candela per metre square (cd/m²). A liquid crystal display (LCD) backlit by an instant fluorescent light emitter typically has a peak luminance of around three hundred to five hundred (300-500) cd/m² and a dynamic range of one to eight hundred (1:800). CRT displays and liquid crystal display (LCD) displays are examples of standard dynamic range (SDR) displays. Standard dynamic range (SDR) displays usually have a colour gamut approximately equal to the gamut specified by the ITU-R BT.709 Recommendation ‘Parameter values for the HDTV standards for production and international programme exchange’ which covers approximately thirty nine (39) percents of the human-visible gamut.

Organic light-emitting diode (OLED) displays have peak luminance values of up to eight hundred (800) and one thousand (1000) cd/m². Liquid crystal display (LCD) displays backlit by a grid of independently modulated light emitting diodes (LEDs) have peak luminance values of one thousand (1000), two thousand (2000) and four thousand (4000) cd/m² and a dynamic range of one to twenty thousand (1:20000). Organic light-emitting diode (OLED) displays and crystal display (LCD) displays backlit by a grid of independently modulated light emitting diodes (LEDs) are examples of high dynamic range (HDR) displays. Some high dynamic range (HDR) displays have colour gamut approximately equal to the Digital Cinema Initiatives (DCI) P3 colour gamut, which covers approximately forty two (42) percent of the human-visible gamut. Some high dynamic range (HDR) displays have a colour gamut approximately equal to the Adobe RGB colour gamut, which covers approximately fifty two (52) percents of the human-visible gamut. The most advanced high dynamic range (HDR) displays available today have colour gamut close to the gamut specified by the ITU-R BT.2020 Recommendation ‘Parameter values for ultra-high definition television systems for production and international programme exchange’ which covers approximately seventy five (75) percent of the human-visible gamut.

Further progress in development of display technologies will enable commercial availability of display devices with peak luminance of ten thousand (10000) cd/m² and higher and with colour gamut close to the full human-visible gamut.

Present and future availability of display devices with a broad variety of peak luminance values and colour gamuts poses a challenge to reproduction of video content with highest possible quality on all such display devices.

### SUMMARY

It is an object of the present invention to overcome, or at least ameliorate, one or more disadvantages of existing arrangements.

According to an aspect of the present disclosure, there is provided a method of displaying video data on a first display device, the method comprising:

decoding a plurality of display device profiles from a bitstream containing the video data, each of the plurality of display device profiles containing device information comprising display luminance, contrast ratio and colour gamut of a target display device;

selecting a display device profile from the decoded plurality of display device profiles by comparing at least a portion of the device information of the display device profiles with corresponding device information of the first display device;

selecting an image modification parameter set from a plurality of image modification parameter sets according to the selected display device profile, the plurality of image modification parameter sets being decoded from the bitstream and each of the plurality of image modification parameter sets providing information regarding luminance mapping to be applied to one or more portions of the video data from the bitstream of video data; and

displaying at least a portion of the video data on the first display device from the bitstream of video data by applying the selected image modification parameter set to the portion of video data from the bitstream of video data.

According to another aspect of the present disclosure, there is provided an apparatus for displaying video data on a first display device, the apparatus comprising:

decoding module for decoding a plurality of display device profiles from a bitstream containing the video data, each of the plurality of display device profiles containing device information comprising display luminance, contrast ratio and colour gamut of a target display device;

display device profile selection module for selecting a display device profile from the decoded plurality of display device profiles by comparing at least a portion of the device information of the display device profiles with corresponding device information of the first display device;

modification parameter selection module for selecting an image modification parameter set from a plurality of image modification parameter sets according to the selected display device profile, the plurality of image modification parameter sets being decoded from the bitstream and each of the plurality of image modification parameter sets providing information regarding luminance mapping to be applied to one or more portions of the video data from the bitstream of video data; and

display module for displaying at least a portion of the video data on the first display device from the bitstream of video data by applying the selected image modification parameter set to the portion of video data from the bitstream of video data.

According to still another aspect of the present disclosure, there is provided a system for displaying video data on a first display device, the system comprising:

a memory for storing data and a computer program;

a processor coupled to the memory for executing said computer program, said computer program comprising instructions for:
decoding a plurality of display device profiles from a bitstream containing the video data, each of the plurality of display device profiles containing device information comprising display luminance, contrast ratio and colour gamut of a target display device;
selecting a display device profile from the decoded plurality of display device profiles by comparing at least a portion of the device information of the display device profiles with corresponding device information of the first display device;
selecting an image modification parameter set from a plurality of image modification parameter sets according to the selected display device profile, the plurality of image modification parameter sets being decoded from the bitstream and each of the plurality of image modification parameter sets providing information regarding luminance mapping to be applied to one or more portions of the video data from the bitstream of video data; and
displaying at least a portion of the video data on the first display device from the bitstream of video data by applying the selected image modification parameter set to the portion of video data from the bitstream of video data.

According to still another aspect of the present disclosure, there is provided a computer readable medium having a computer program stored thereon for displaying video data on a first display device, the program comprising:

code for decoding a plurality of display device profiles from a bitstream containing the video data, each of the plurality of display device profiles containing device information comprising display luminance, contrast ratio and colour gamut of a target display device;

code for selecting a display device profile from the decoded plurality of display device profiles by comparing at least a portion of the device information of the display device profiles with corresponding device information of the first display device;

code for selecting an image modification parameter set from a plurality of image modification parameter sets according to the selected display device profile, the plurality of image modification parameter sets being decoded from the bitstream and each of the plurality of image modification parameter sets providing information regarding luminance mapping to be applied to one or more portions of the video data from the bitstream of video data; and

code for displaying at least a portion of the video data on the first display device from the bitstream of video data by applying the selected image modification parameter set to the portion of video data from the bitstream of video data.

Other aspects are also disclosed.

### BRIEF DESCRIPTION OF THE DRAWINGS

At least one arrangement of the present invention will now be described with reference to the following drawings and and appendices, in which:

FIG. 1 is a schematic flow diagram of a video processing software architecture;

FIGS. 2A and 2B form a schematic block diagram of a general purpose computer system upon which described arrangements may be practiced;

FIG. 3A is a schematic diagram of a colour remapping information (CRI) structure;

FIG. 3B is a schematic diagram of an alternative colour remapping information (CRI) structure;

FIG. 4A is a schematic diagram of a target device profile (TDP) structure;

FIG. 4B is a schematic diagram showing an arrangement of the colour remapping information (CRI) structure;

FIG. 4C is a schematic diagram showing an arrangement of a supplementary enhancement information (SEI) message structure;

FIG. 5 is a schematic flowchart diagram showing a method displaying video data of an image;

FIG. 6 is a schematic diagram showing the CIE 1931 xy chromaticity diagram with colour gamuts;

FIG. 7 is a schematic diagram showing a video processing software architecture according to another arrangement;

FIG. 8 is a schematic diagram showing a structure of an HDMI CEC InfoFrame packet;

Appendix A shows an algorithm for determining a maximum content luminance level (MaxCLL) value;

Appendix B shows an algorithm for determining a minimum content luminance level (MinCLL) value; and

Appendix C shows an algorithm for determining a maximum frame-average luminance level (MaxFALL) value.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

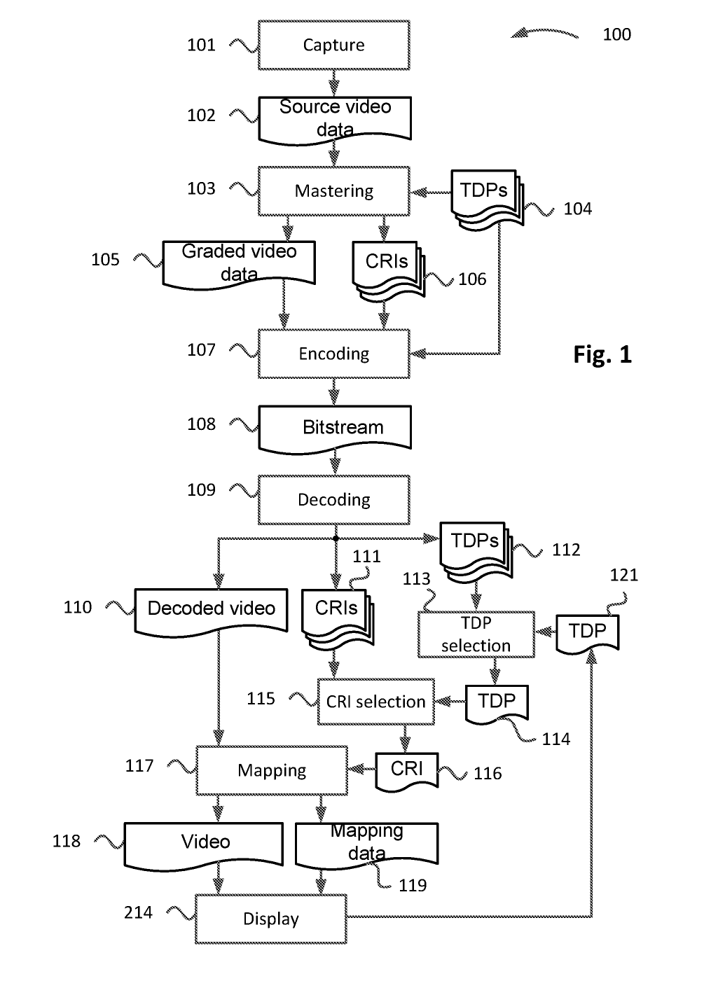

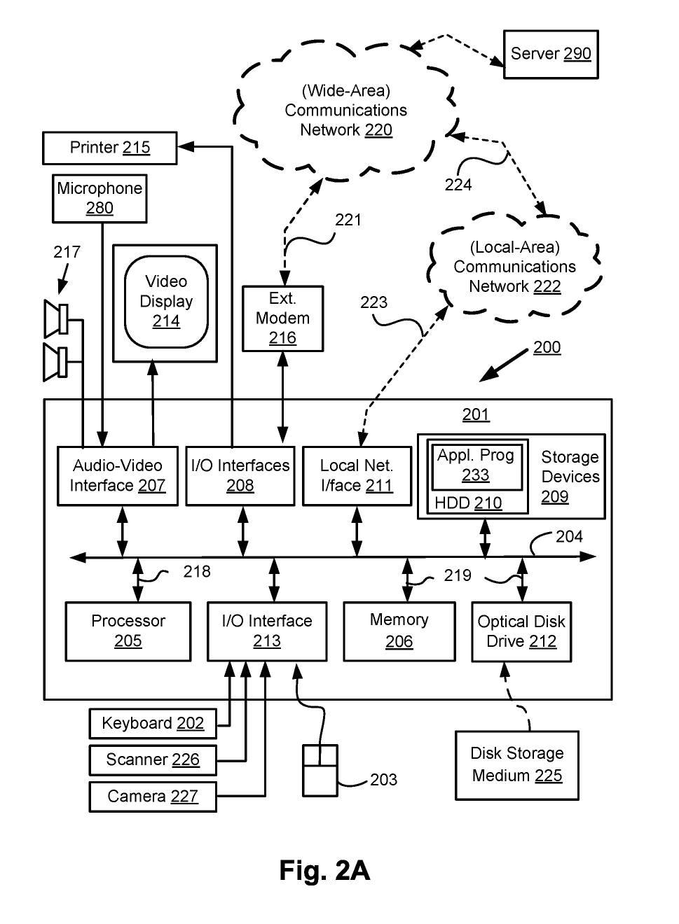

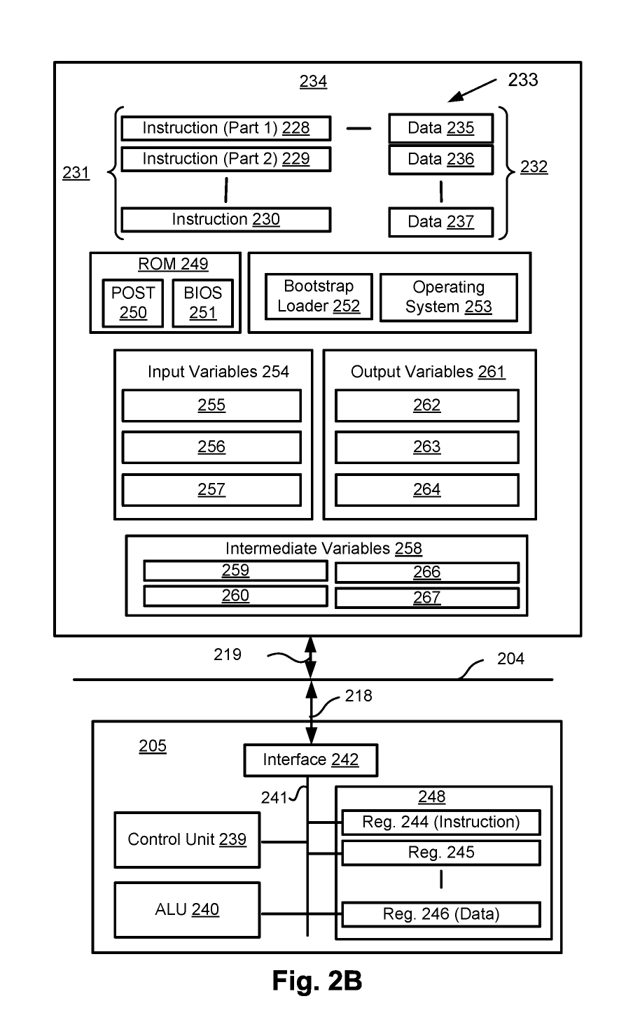

FIG. 1 is a schematic block diagram of a video processing software architecture 100 that illustrates software modules 101, 103, 107, 109, 113, 115 and 117 configured for capturing video data through to displaying video data to a human viewer. Each of the software modules 101, 103, 107, 109, 113, 115 and 117 may be implemented as one or more software code modules of a software application program 233 resident in a hard disk drive 210 and being controlled in its execution by a processor 205 of a computer system 200 which will be described in detail below with reference to FIGS. 2A and 2B.

The video processing software architecture 100 supports display of video data on a variety of displays, where each of the displays having different capabilities. For example. a given display may include capabilities such as display peak luminance and colour gamut. The video processing software architecture 100 is responsive to the type of display, adapting the video data to suit the particular display in use.

As seen in FIG. 1, a video capture module 101 is used to capture source video data 102 using a video camera 227 (see FIG. 2A) for example. Alternatively, the video capture module 101 may synthesize the source video data 102 using computer generated graphics functionality. If the source video data 102 is captured, the video camera 227 used is equipped with an imaging sensor, such as a charge-coupled device (CCD) or a complementary metal-oxide-semiconductor (CMOS) imaging sensor. Source video data 102 captured by the video camera 227 may have a standard dynamic range (SDR) or high dynamic range (HDR). Contemporary high-end cameras offer a dynamic range of up to fifteen (15) f-stops (a contrast ratio of 1:2¹⁵). Contemporary high dynamic range (HDR) image and video storage formats, which may be used for storing of both camera-captured and computer-generated video data, may use high precision floating point formats, such as the single precision and double precision formats specified by the IEEE 754 standard supporting dynamic ranges of up to two hundred fifty six (256) f-stops (a contrast ratio of 1:2²⁵⁶) and up to two thousands and forty eight (2048) f-stops (a contrast ratio of 1:2²⁰⁴⁸) respectively.

A mastering module 103 performs mastering (one aspect of which is known as ‘colour grading’) of the source video data 102 captured by the module 101. The mastering may be performed automatically, or under the control of a human operator using input devices (e.g., keyboard 202, mouse pointer device 203). Mastering performed by the module 103 includes altering the colours and luminance of the source video data 102, typically for maintaining artistic consistency and creating a desired ‘look’ for the source video data 102 where the video data 102 may include multiple shots, captured under different conditions. Alternatively, the mastering may be performed by the module 103 for matching luminance and colour characteristics of a target display device.

The display devices on which the source video data 102 is to be reproduced may differ in luminance and colour characteristics, such as minimum and maximum luminance, dynamic range, colour gamut, and white point. The luminance, dynamic range, colour gamut and white point characteristics of a display device are collectively referred to as a ‘display profile’ for the display device. The mastering module 103 performs mastering of the source video data 102, such that multiple display profiles are supported. In particular, different versions of the mastered source video data 102 can be produced according to the supported display profiles. The mastering module 103 uses target device profile (TDP) structures 104, with the target device profile (TDP) structures 104 including one target device profile (TDP) structure for each display profile. Each of the target device profile (TDP) structures 104 includes a display profile. The mastering module 103 produces graded video data 105, suitable for displaying on display devices with a particular display profile. The mastering module 103 also produces one or more colour remapping information (CRI) messages 106. Each colour remapping information (CRI) message is associated with a target device profile (TDP). Each colour remapping information (CRI) message defines an image modification parameter set including a colour gamut and dynamic range mapping providing information regarding luminance mapping. The colour gamut and dynamic range mapping is applied to the graded video data 105 prior to display on a display device that has a display profile compatible with the target device profile (TDP) message associated with the colour remapping information (CRI) message. Such modifications are collectively referred to as ‘mapping’.

As an example, the source video data 102 may be mastered for a display profile ‘A’ with a luminance range of zero point zero one (0.01) cd/m² to one thousand (1000) cd/m² and use the ITU-R BT.2020 colour gamut, resulting in graded video data 105. In the example, a target device profile (TDP) message describes a display profile ‘B’ with a luminance range of zero point zero one (0.01) cd/m² to of one hundred (100) cd/m², and uses the ITU-R BT.709 colour gamut. A colour remapping information (CRI) message associated with the target device profile (TDP) message describing the profile ‘B’ includes information to modify the luminance range and perform colour gamut conversion of the graded video data 105, graded for the profile ‘A’, to make the graded video data 105 suitable for displaying on a display with the profile ‘B’. Arrangements of target device profile (TDP) and colour remapping information (CRI) structures are described below.

An encoding module 107 encodes the video data 105, the colour remapping information (CRI) messages 106 and the target device profile (TDP) messages 104 into a bitstream 108. The bitstream 108 is compliant with a video coding standard, such as H.264/MPEG-4 Part 10, Advanced Video Coding (AVC) or H.265/MPEG-H Part 2 High Efficiency Video Coding (HEVC). The colour remapping information (CRI) messages 106 and target device profile (TDP) messages 104 are encoded into the bitstream 108 as supplementary enhancement information (SEI) messages, or as a part of the video usability information (VUI) messages. Alternatively, one or both of the colour remapping information (CRI) messages and the target device profile (TDP) messages may be conveyed separately to the bitstream 108. For example, communication network 220 (see FIG. 2A) may convey the bitstream 108 in a ‘data channel’ and additional messages, such as the above supplementary enhancement (SEI) messages may be conveyed in a separate ‘control channel’ (also known as a ‘side channel’).

A decoding module 109 decodes the bitstream 108 to produce decoded video data 110, also extracting one or more colour remapping information (CRI) messages 111 and one or more target device profiles (TDP) 112 from the bitstream 108. As described above, each of the remapping information (CRI) messages 111 comprises an image modification parameter set which is decoded from the bitstream 108. As such, decoding a plurality of colour remapping information (CRI) messages 111 produces a plurality of image modification parameter sets. A target device profile (TDP) 121 provides a display profile of display device 214 (see FIG. 2).

A target device profile (TDP) selection module 113 selects a target device profile (TDP) 114 from the one or more target device profiles (TDP) 112 using the target device profile (TDP) 121. Arrangements of the target device profile (TDP) selection module 113 are described below.

A colour remapping information (CRI) selection module 115 selects a colour remapping information (CRI) message 116 from the one or more colour remapping information (CRI) messages 111 using the target device profile (TDP) 114. Arrangements of the colour remapping information (CRI) selection module 115 are described below.

A mapping module 117 maps each image of the decoded video data 110 into an image of mapped video data 118 in accordance with the colour remapping information (CRI) message 116. As the mapping is performed using a colour remapping information (CRI) message associated with the target device profile (TDP) 121, the mapped video data 118 is suitable for displaying on the display device 214. In an arrangement of the architecture 100, the mapping module 117 performs mapping of images of the video data 110 into the video data 118 by modifying samples of the images of the video data 118. In another arrangement, the mapping module 117 produces a mapping data 119 that at least partially includes the information present in the colour remapping information (CRI) message 116. The mapping data 119 is then provided to the display device 214. In the arrangement of FIG. 1, the display device 214 includes the capability to perform colour gamut remapping, using the provided mapping data 119. Further detailed arrangements of the mapping module 117 are described below.

The display device 214 displays the mapped video data 118. In arrangements where the mapping data 119 is provided to the display device 214, the display device 214 performs the mapping prior to display.

In an alternative arrangement of the video processing software arrangement 100, one or both of the colour remapping information (CRI) messages and the target device profiles (TDP) are not conveyed in a ‘side channel’ as such. Instead, the colour remapping information (CRI) messages and the target device profiles (TDP) are predetermined and thus are stored (e.g. using read-only memory (ROM) 249 as seen in FIG. 2B), accessible to the target device profile (TDP) selection module 113 or the colour remapping information (CRI) selection module 115. The target device profiles (TDP) 112 and the colour remapping information (CRI) messages 111 may be stored in the read-only memory (ROM) 249 of corresponding modules.

In an alternative arrangement of the video processing software architecture 100, the colour remapping information (CRI) selection module 115 receives a mastering display colour volume supplementary enhancement information (SEI) message from the decoding module 109. The mastering display colour volume supplementary enhancement information (SEI) message specifies the colour volume (i.e., the colour primaries, white point and luminance range) of a display considered to be used by the mastering module 103. The colour remapping information (CRI) selection module 115 then creates the colour remapping information (CRI) message 116 to map the video data 110 from a display profile specified by the mastering display colour volume supplementary enhancement information (SEI) message to the display profile specified by the target device profile (TDP) message 114. For example, if the mastering display colour volume supplementary enhancement information (SEI) message, received by the colour remapping information (CRI) selection module 115 from the decoding module 109 specifies colour primaries of the BT.2020 colour gamut and a peak luminance of four thousand (4000) cd/m², and the target display profile (TDP) message 114 specifies colour primaries of the BT.709 colour gamut and a peak luminance of one thousand (1000) cd/m², then the colour remapping information (CRI) message 116 will include a look-up table (LUT). The look-up table (LUT) maps the luminance from four thousand (4000) cd/m² to one thousand (1000) cd/m². The colour remapping information (CRI) message 116 will also include a matrix to map colour information from the BT.2020 colour gamut into the BT.709 colour gamut.

Notwithstanding the example devices and modules mentioned above, each of the devices and modules of the video processing software architecture 100 may be configured within a general purpose computing system, typically through a combination of hardware and software components. FIG. 2A illustrates such a computer system 200, which includes: a computer module 201; input devices such as the keyboard 202, the mouse pointer device 203, a scanner 226, the video camera 227, and a microphone 280; and output devices including a printer 215, the display device 214 and loudspeakers 217. An external Modulator-Demodulator (Modem) transceiver device 216 may be used by the computer module 201 for communicating to and from the communications network 220 via a connection 221. The communications network 220, may be a wide-area network (WAN), such as the Internet, a cellular telecommunications network, or a private WAN. Where the connection 221 is a telephone line, the modem 216 may be a traditional “dial-up” modem. Alternatively, where the connection 221 is a high capacity (e.g., cable) connection, the modem 216 may be a broadband modem. A wireless modem may also be used for wireless connection to the communications network 220.

The computer module 201 typically includes at least one processor unit 205, and a memory unit 206. For example, the memory unit 206 may have semiconductor random access memory (RAM) and semiconductor read only memory (ROM). The computer module 201 also includes an number of input/output (I/O) interfaces including: an audio-video interface 207 that couples to the video display 214, loudspeakers 217 and microphone 280; an I/O interface 213 that couples to the keyboard 202, mouse 203, scanner 226, camera 227 and optionally a joystick or other human interface device (not illustrated); and an interface 208 for the external modem 216 and printer 215. The signal from the audio-video interface 207 to the computer monitor 214 is generally the output of a computer graphics card. In some implementations, the modem 216 may be incorporated within the computer module 201, for example within the interface 208. The computer module 201 also has a local network interface 211, which permits coupling of the computer system 200 via a connection 223 to a local-area communications network 222, known as a Local Area Network (LAN). As illustrated in FIG. 2A, the local communications network 222 may also couple to the wide network 220 via a connection 224, which would typically include a so-called “firewall” device or device of similar functionality. The local network interface 211 may comprise an Ethernet™ circuit card, a Bluetooth™ wireless arrangement or an IEEE 802.11 wireless arrangement; however, numerous other types of interfaces may be practiced for the interface 211. The local network interface 211 may be embodied in the local communications network 222.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g. CD-ROM, DVD, Blu-ray Disc™), USB-RAM, portable, external hard drives, and floppy disks, for example, may be used as appropriate sources of data to the computer system 200. Typically, any of the HDD 210, optical drive 212, networks 220 and 222 may also be configured to operate as a destination for decoded video data to be stored for reproduction via the display 214.

The components 205 to 213 of the computer module 201 typically communicate via an interconnected bus 204 and in a manner that results in a conventional mode of operation of the computer system 200 known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practised include IBM-PC's and compatibles, Sun SPARCstations, Apple Mac™ or alike computer systems.

Where appropriate or desired, the methods described below, may be implemented using the computer system 200 wherein described devices, modules and methods of the video processing software architecture 100, may be implemented as one or more software application programs 233 executable within the computer system 200. In particular, the devices, modules and the steps of the described methods are effected by instructions 231 (see FIG. 2B) in the software 233 that are carried out within the computer system 200. The software instructions 231 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software is loaded into the computer system 200 from the computer readable medium, and then executed by the computer system 200. A computer readable medium having such software or computer program recorded on the computer readable medium is a computer program product. The use of the computer program product in the computer system 200 preferably effects an advantageous apparatus for implementing the devices, modules and the described methods of the video processing software architecture 100.

The software 233 is typically stored in the HDD 210 or the memory 206. The software is loaded into the computer system 200 from a computer readable medium, and executed by the computer system 200. Thus, for example, the software 233 may be stored on an optically readable disk storage medium (e.g., CD-ROM) 225 that is read by the optical disk drive 212.

In some instances, the application programs 233 may be supplied to the user encoded on one or more CD-ROMs 225 and read via the corresponding drive 212, or alternatively may be read by the user from the networks 220 or 222. Still further, the software can also be loaded into the computer system 200 from other computer readable media. Computer readable storage media refers to any non-transitory tangible storage medium that provides recorded instructions and/or data to the computer system 200 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of the software, application programs, instructions and/or video data or encoded video data to the computer module 201 include radio or infra-red transmission channels as well as a network connection to another computer or networked device, and the Internet or Intranets including e-mail transmissions and information recorded on Websites and the like.

The second part of the application programs 233 and the corresponding code modules mentioned above may be executed to implement one or more graphical user interfaces (GUIs) to be rendered or otherwise represented upon the display 214. Through manipulation of typically the keyboard 202 and the mouse 203, a user of the computer system 200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280.

FIG. 2B is a detailed schematic block diagram of the processor 205 and a “memory” 234. The memory 234 represents a logical aggregation of all the memory modules (including the HDD 210 and semiconductor memory 206) that can be accessed by the computer module 201 in FIG. 2A.

When the computer module 201 is initially powered up, a power-on self-test (POST) program 250 executes. The POST program 250 is typically stored in a ROM 249 of the semiconductor memory 206 of FIG. 2A. A hardware device such as the ROM 249 storing software is sometimes referred to as firmware. The POST program 250 examines hardware within the computer module 201 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 2A. Activation of the hard disk drive 210 causes a bootstrap loader program 252 that is resident on the hard disk drive 210 to execute via the processor 205. This loads an operating system 253 into the RAM memory 206, upon which the operating system 253 commences operation. The operating system 253 is a system level application, executable by the processor 205, to fulfil various high level functions, including processor management, memory management, device management, storage management, software application interface, and generic user interface.

The operating system 253 manages the memory 234 (209, 206) to ensure that each process or application running on the computer module 201 has sufficient memory in which to execute without colliding with memory allocated to another process.

Furthermore, the different types of memory available in the computer system 200 of FIG. 2A must be used properly so that each process can run effectively. Accordingly, the aggregated memory 234 is not intended to illustrate how particular segments of memory are allocated (unless otherwise stated), but rather to provide a general view of the memory accessible by the computer system 200 and how such is used.

As shown in FIG. 2B, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using a connection 218. The memory 234 is coupled to the bus 204 using a connection 219.

The application program 233 includes a sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices 202, 203, data received from an external source across one of the networks 220, 202, data retrieved from one of the storage devices 206, 209 or data retrieved from a storage medium 225 inserted into the corresponding reader 212, all depicted in FIG. 2A. The execution of a set of the instructions may in some cases result in output of data. Execution may also involve storing data or variables to the memory 234.

The devices, modules and the described methods of the video processing software architecture 100 may use input variables 254, which are stored in the memory 234 in corresponding memory locations 255, 256, 257. The display devices, modules and the described methods of the video processing architecture 100 may produce output variables 261, which are stored in the memory 234 in corresponding memory locations 262, 263, 264. Intermediate variables 258 may be stored in memory locations 259, 260, 266 and 267.

Referring to the processor 205 of FIG. 2B, the registers 244, 245, 246, the arithmetic logic unit (ALU) 240, and the control unit 239 work together to perform sequences of micro-operations needed to perform “fetch, decode, and execute” cycles for every instruction in the instruction set making up the program 233. Each fetch, decode, and execute cycle comprises:

(a) a fetch operation, which fetches or reads an instruction 231 from a memory location 228, 229, 230;

(b) a decode operation in which the control unit 239 determines which instruction has been fetched; and

(c) an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

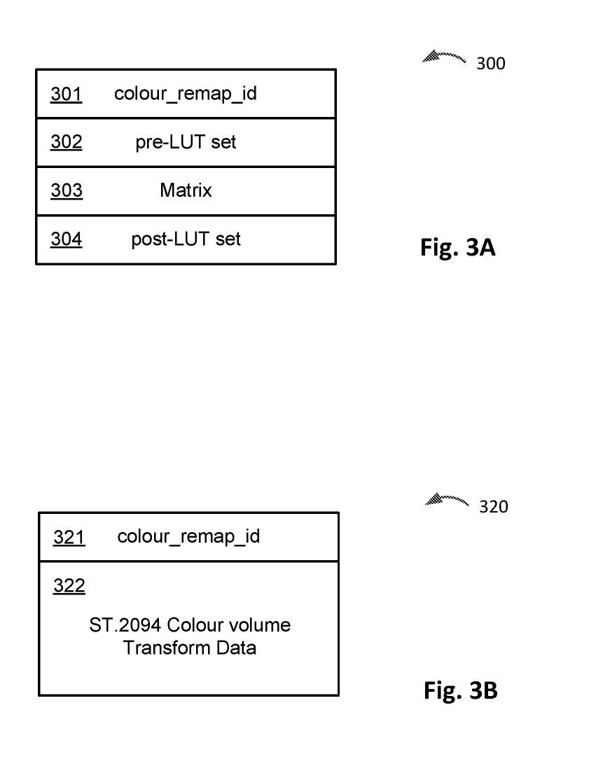

FIG. 3A is a schematic diagram showing a colour remapping information (CRI) structure 300. The colour remapping information (CRI) structure 300 is used to store information to remap luminance (and, consequently, dynamic range) and convert the colour gamut of images of video data. A colour_remap_id 301 identifies an instance of the colour remapping information (CRI) structure 300. A pre-processing lookup table (pre-LUT) set structure 302 includes three (i.e., one per colour channel) tables of pairs of numeric values, where a first value in a pair identifies an input sample value and a second value identifies a corresponding output sample value. The pairs of numeric values can thus be used to define for each colour channel a precise map from one dynamic range to another, or an approximation using, for example, a piecewise linear model. A matrix structure 303 includes nine (9) coefficients (i.e. fields), representing a three by three (3×3) transformation matrix. The matrix structure 303 may be used to assist in colour gamut transformation, e.g. from a larger colour gamut (e.g. ITU-R BT.2020) to a smaller colour gamut (e.g. ITU-R BT.709). A post-processing lookup table (post-LUT) set structure 304 is a per-channel of look-up table (LUT) set structure similar to the pre-LUT set structure 302.

The colour remapping information (CRI) structure 300 may be applied to an image of video data as follows: each of the tables of the pre-LUT set structure 302 is applied to samples of the respective colour channels, to convert the samples from a perceptually uniform luminance domain into a linear light domain. The fields of matrix structure 303 form a matrix multiplication operation that is applied to triplets, comprising collocated samples of the three colour channels, to perform colour gamut conversion. Each of the tables of the post-LUT set structure 304 is applied to samples of the respective colour channels to convert the samples from the linear light domain to a luminance domain, matching display profile of a display device.

FIG. 3B is a schematic diagram showing a colour remapping information (CRI) structure 320. The colour remapping information (CRI) structure 320 is used to store information to remap luminance (and, consequently, dynamic range) and convert the colour gamut of images of video data. A colour_remap_id 321 identifies an instance of the colour remapping information (CRI) structure 320. A field 322 includes a colour volume transform information specified by the Society of Motion Picture and Television Engineers (SMPTE) standard (currently under development) for Content-Dependent Metadata for Color Volume Transformation of High Luminance and Wide Color Gamut Images, the standard being also known as SMPTE ST.2094.

In arrangements of the software architecture 100, the colour remapping information (CRI) structure 320 may be used as an alternative to the colour remapping information (CRI) structure 300.

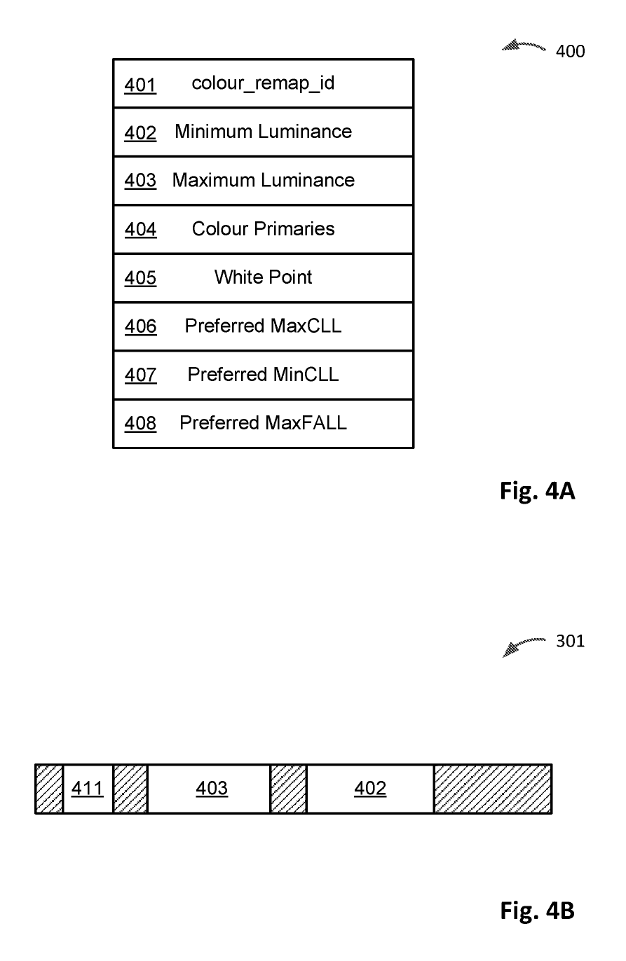

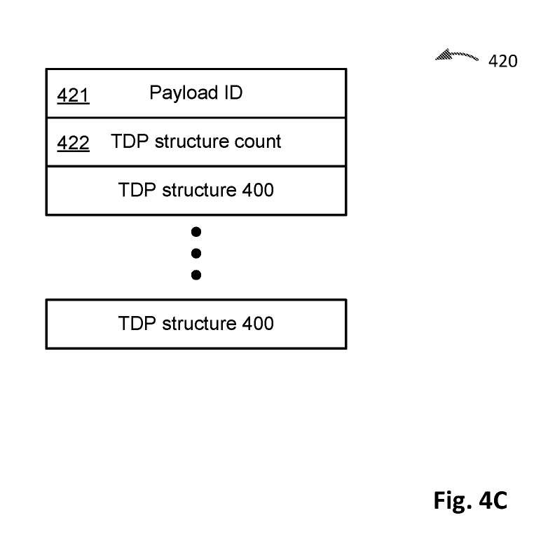

FIG. 4A is a schematic diagram showing a target device profile (TDP) structure 400. The target device profile (TDP) structure 400 includes information necessary to specify a target device profile (TDP). A colour_remap_id 401 identifies a colour remapping information (CRI) structure 300 that is associated with the present target device profile (TDP) structure 400.

A minimum luminance 402 and a maximum luminance 403 specify the minimum and maximum luminance levels available for the present target device profile (TDP), respectively. The minimum luminance 402 and the maximum luminance 403 represent the luminance in cd/m² as numbers, with up to three significant digits and up to four decimal places provided for the minimum luminance 402 and the maximum luminance 403 being a number with up to four significant digits and up to two decimal places. In one arrangement of the target device profile (TDP) structure 400, the minimum luminance 402 and the maximum luminance 403 are represented by IEEE-754 sixteen (16) bit ‘half precision’ floating point values. In another arrangement of the target device profile (TDP) structure 400, the luminance fields 402 and 403 are represented by fixed-point numbers (i.e. numbers with a pre-defined number of digits after the radix point, including, but not limited to integer numbers). In another arrangement of the target device profile (TDP) structure 400, the minimum luminance 402 and the maximum luminance 403 represent scaled minimum and maximum luminance values, respectively. The minimum and maximum luminance values of the display device (e.g., 214) are derived from the minimum luminance 402 and the maximum luminance 403 using Equations (1) and (2) as follows:

Lmax=50*2^{(Cmax/32)} (1)

Lmin=Lmax*(Cmin/255)²/100 (2)

where is Lmax the maximum luminance value, Cmax is the value of the maximum luminance 403, Lmin is the minimum luminance value, and Cmin is the value of the minimum luminance 402.

In Equation (1), the value of Lmax has an exponential dependency on the value of Cmax. The arrangement of the Equation (1) allows the maximum luminance field 403 to be represented in a compressed form using less bits compared to a linear equation.

In Equation (2), the value of Lmin has a linear dependency on the value of Lmax and a quadratic dependency on the value of Cmin. The arrangement of the Equation (2) provides a sufficient precision and value range to represent the minimum luminance field 402 value.

In one arrangement of the target device profile (TDP) structure 400, the minimum luminance 402 and the maximum luminance 403 are unsigned integers having range zero (0) to two hundred fifty five (255), affording a range of Lmax of fifty (50) to approximately twelve thousand five hundred twenty six (12526) and a range of Lmin of zero (0) to approximately one hundred twenty five (125).

A colour primaries field 404 specifies the three colour primaries that a display device, such as the display device 214, is capable of producing. The colour primaries are specified using the CIE 1931 xy chromaticity diagram, generally by subdividing the x and y axes into 50,000 points each, enabling a given colour primary to be specified using a pair of 16-bit integers. The colour primaries field 404 thus contains three pairs of 16-bit integers to specify the red, green and blue primaries.

In one arrangement of the target device profile (TDP) structure 400, the colour primaries field 404 includes three pairs of numbers representing chromaticity coordinates for the red, green and blue primary colours on the CIE 1931 xy chromaticity diagram, each of the numbers having four decimal places. For example, if the display device 214 has the colour gamut described by the Recommendation ITU-R BT.1886 ‘Reference electro-optical transfer function for flat panel displays used in HDTV studio production’, the field 404 contains three pairs of (x, y) values (0.640, 0.330), (0.300, 0.600), (0.150, 0.060) for red, green and blue coordinates correspondingly. In one arrangement of the target device profile (TDP) structure 400, the chromaticity coordinates are represented by fixed-point numbers. In another arrangement of the target device profile (TDP) structure 400, the chromaticity coordinates are represented by IEEE-754 sixteen (16) bit ‘half precision’ floating point values.

A white point field 405 specifies the white point coordinates of the display device colour gamut. In one arrangement of the target device profile (TDP) structure 400, the white point field 405 includes one pair of numbers with four decimal places representing a coordinate for the white point on the CIE 1931 xy chromaticity diagram. For example, if the display device 214 supports the colour gamut described by the Recommendation ITU-R BT.1886 ‘Reference electro-optical transfer function for flat panel displays used in HDTV studio production’, the field 405 contains one pair of (x, y) values (0.3127, 0.3290) for the white point coordinate. In one arrangement of the target device profile (TDP) structure 400, the chromaticity coordinates are represented by fixed-point numbers, e.g. by dividing the x and y components into 50,000 places and using a 16-bit integer to represent each component. In another arrangement of the target device profile (TDP) structure 400, the white point coordinates are represented as IEEE-754 sixteen (16) bit ‘half precision’ floating point values.

A preferred MaxCLL field 406 specifies the maximum content luminance level (MaxCLL) preferred by a display device 214. The maximum content luminance level (MaxCLL) is the maximum image sample value over all samples of all images in a video sequence. The MaxCLL value of the field 406 is determined using Algorithm A.1 as shown in Appendix A. The function linearize (R′, G′, B′) converts values R′, G′, B′ from the perceptually uniform domain into linear light domain values R, G, B.

In one arrangement of the target device profile (TDP) structure 400, the field 406 specifies the preferred maximum content luminance level (MaxCLL) in cd/m².

In one arrangement of the target device profile (TDP) structure 400, the field 406 is a scaled value of the preferred maximum content luminance level (MaxCLL). The preferred maximum content luminance level (MaxCLL) is derived from the field 406 using Equation (3) as follows:

MaxCLL=50*2^{(L/32)} (3)

where MaxCLL is the preferred maximum content luminance level (MaxCLL); and L is an integer stored as value of the preferred MaxCLL field 406. In the arrangement of Equation (3), the preferred MaxCLL field 406 is an unsigned integer having range zero (0) to two hundred fifty five (255), affording a range of MaxCLL of fifty (50) to approximately twelve thousand five hundred and twenty six (12526).

In the Equation (3), the value of MaxCLL has an exponential dependency on the value of L. The arrangement of the Equation (3) allows the preferred maximum content luminance level field 406 to be represented in a compressed form using fewer bits compared to a linear equation.

A preferred MinCLL field 407 specifies the minimum content luminance level (MinCLL) preferred by the display device. The minimum content luminance level (MinCLL) indicates the minimum image sample value over all samples of all images in a video sequence.

In one arrangement of the target device profile (TDP) structure 400, the MinCLL value of the preferred MinCLL field 407 is determined using Algorithm B.1 from Appendix B. In Algorithm B.1, the function linearize(R′, G′, B′) converts values R′, G′, B′ from a perceptually uniform domain into linear light domain values R, G, B.

In one arrangement of the target device profile (TDP) structure 400, the preferred MinCLL field 407 is the value of the preferred minimum content luminance level (MinCLL) in cd/m².

In another arrangement of the target device profile (TDP) structure 400, the preferred MinCLL field 407 may represent the preferred minimum content luminance level (MinCLL) as a scaled value of the preferred minimum content luminance level (MinCLL). The preferred minimum content luminance level (MinCLL) may thus be derived from the preferred MinCLL field 407 using Equation (4) as follows:

MinCLL=MaxCLL·(L/255)²/100 (4)

where MinCLL is the preferred minimum content luminance level (MinCLL); MaxCLL is the preferred maximum content luminance level (MaxCLL) from the Equation (3) above; and L is the value of the field 407. In the arrangement of Equation (4), the preferred MinCLL field 407 is an unsigned integer having range zero (0) to two hundred fifty five (255), affording a range of MinCLL of zero (0) to approximately one hundred and twenty five (125).

In the Equation (4), the value of MinCLL has a linear dependency on the value of MaxCLL and a quadratic dependency on the value of L. The arrangement of the Equation (4) provides a sufficient precision and value range to represent the preferred minimum content luminance level field 407 value.

A preferred MaxFALL field 408 specifies the maximum frame-average luminance level (MaxFALL) preferred by the display device. An example of a ‘preferred’ MaxFALL value is a maximum light level a display can reproduce without resulting in excessive power consumption. The maximum frame-average luminance level (MaxFALL) specifies the maximum of per-frame average image sample values over all samples in an image, for all images in a video sequence. The MaxFALL value of the preferred MaxFALL field 408 is determined using Algorithm C.1 from Appendix C. The function linearize(R′, G′, B′) of Appendix C converts values R′, G′, B′ from the perceptually uniform domain into linear light domain values R, G, B. In one arrangement of the target device profile (TDP) structure 400, the field 408 is a value in cd/m².

In another arrangement of the target device profile (TDP) structure 400, the preferred MaxFALL field 408 represents a scaled value of the preferred maximum frame-average luminance level (MaxFALL). The preferred maximum frame-average luminance level (MaxFALL) is derived from the field 408 using Equation (5) as follows:

MaxFALL=50*2^{(L/32)} (5)

where MaxFALL is the preferred maximum frame-average luminance level (MaxFALL); and L is the value of the field 408. In the arrangement of Equation (5), the preferred MaxFALL field 408 is an unsigned integer having range zero (0) to two hundred fifty five (255), affording a range of MaxFALL of fifty (50) to approximately twelve thousand five hundred twenty six (12526).

In the Equation (5), the value of MaxFALL has an exponential dependency on the value of L. The arrangement of the Equation (5) allows the preferred maximum frame-average luminance level field 408 to be represented in a compressed form using less bits compared to a linear equation. In one arrangement of the video processing software architecture 100, the target device profile (TDP) structure 400 is included in a colour remapping information (CRI) structure 300. The colour_remap_id 401 may be omitted, as the association between a given target display profile (TDP) and the colour remapping information (CRI) is implicit.

Power consumption of a display device is proportional to the luminance of the displayed video data. In one arrangement of the video processing software architecture 100, the target device profile (TDP) message 121 provided by the display device 214 has one or more of the preferred MaxCLL field 408, the preferred MinCLL field 407 and the preferred MaxFALL field 408 values. The MaxCLL field 408, the preferred MinCLL field 407 and the preferred MaxFALL field 408 values are collectively referred to as ‘luminance parameters’, smaller than the values representative of the full capability of the respective display parameters for the display device 214. Selection of the luminance parameters of the display device 214 may be initiated by a human operator. For example, user selection of a ‘low power mode’ may result in selection of the ‘luminance parameters’ rather than parameters representative of the full capability of the display device 214. Then, in the low power mode, the target device profile (TDP) selection module 113, upon receiving the display device profile (TDP) message 121, with reduced values of one or more of the luminance parameters, selects a target profile (TDP) message 114 according to the reduced luminance parameters. The colour remapping information (CRI) selection module 115 selects a colour remapping information (CRI) message with a mapping corresponding to the reduced luminance parameters of the target device profile (TDP) message 114. The mapping module 117 then maps the decoded video data 110 to video data 118 having characteristics corresponding to the reduced luminance parameters mapping 116. The display device 214 displays the video data 118 having the reduced luminance characteristics, thus consuming less electrical power compared to displaying of the same video while exercising normal luminance characteristics (i.e. characteristics representative of the full capability of the display device 214).

Selection of the ‘low power mode’ in the display device 214 may result in advertised capabilities (i.e. the target display profile (TDP) 121) of the display device 214 being reduced. For example, supported peak luminance may be reported at a lower value than true peak luminance capability of the display device 214. As a consequence, the target display profile (TDP) selection module 113 may select a different one of the colour remapping information (CRI) SEI messages 106 (i.e. a colour remapping information (CRI) SEI message intended for a display with lower capabilities than the display device 214). Then, the video data may be rendered according to the reduced capabilities, preserving, as much as possible, the artistic intent, while enabling the display device 214 to achieve power consumption reductions (e.g. by reducing the backlight intensity).

The fields 402 to 408 of the target device profile (TDP) structure 400 specify luminance and colour gamut parameters of video data or a display device in physical and colorimetric units such as cd/m² and the xy colorimetric plane coordinates. The physical and colorimetric units used in the target device profile (TDP) structure 400 have an advantage of being universally recognized (i.e., consistent terminology compared to other syntax for defining colour volume is used), and are interpretable without any additional specifications.

FIG. 4B is a schematic diagram showing an alternative arrangement in which the colour_remap_id 301 of the colour remapping information (CRI) structure 300 is a structure including the minimum luminance 402 and the maximum luminance 403. In the arrangement of FIG. 4B, the minimum luminance 402 and maximum luminance 403 are included in the colour_remap_id field 301. For example, the minimum luminance 402 and the maximum luminance 403 are each represented using 8-bit fixed precision values.

Additionally, the colour_remap_id 301 of the colour remapping information (CRI) structure 300 may also include a colour gamut identifier 411 for the colour gamut indicated by the target device profile (TDP). Each possible value of the colour gamut identifier 411 corresponds to a predetermined device profile that specifies values of colour primaries and white point coordinates on the CIE 1931 xy chromaticity diagram.

The arrangement of the colour_remap_id field 301 of the colour remapping information (CRI) structure 300 described with reference to FIG. 4B allows luminance and colour gamut parameters to be represented compactly.

FIG. 4C is a schematic diagram showing an arrangement of a supplementary enhancement information (SEI) message structure 420. A payload id field 421 is a numeric supplementary enhancement information (SEI) message type identifier serving to distinguish the supplementary enhancement information (SEI) message structure 420 from other supplementary enhancement information (SEI) message structures. A target device profile (TDP) structure count field 422 is an unsigned integer value specifying count of the target device profile (TDP) structures 400 that follow. The target device profile (TDP) structure count field 422 is followed by one or more (as specified by the target device profile (TDP) structure count field 422) target device profile (TDP) structures 400.

The arrangement of the supplementary enhancement information (SEI) message structure 420 allows one or more of the target device profile (TDP) structures 400 to be encapsulated and transmitted as a part of the bitstream 108. As such, a single SEI message, containing multiple TDPs, can be present in the encoded bitstream, reducing the parsing load on an entropy decoder in a video decoder. Moreover, TDPs may be grouped into ‘sets’ of TDPs, each set being coded into one SEI message. Then, an encoder may encode one or more ‘sets’ of TDPs simply by storing the corresponding one or more SEI messages into the bitstream. The SEIs themselves may be pre-determined (e.g. provided by a vendor) for use by encoders to include a corresponding set of TDPs into a given bitstream.

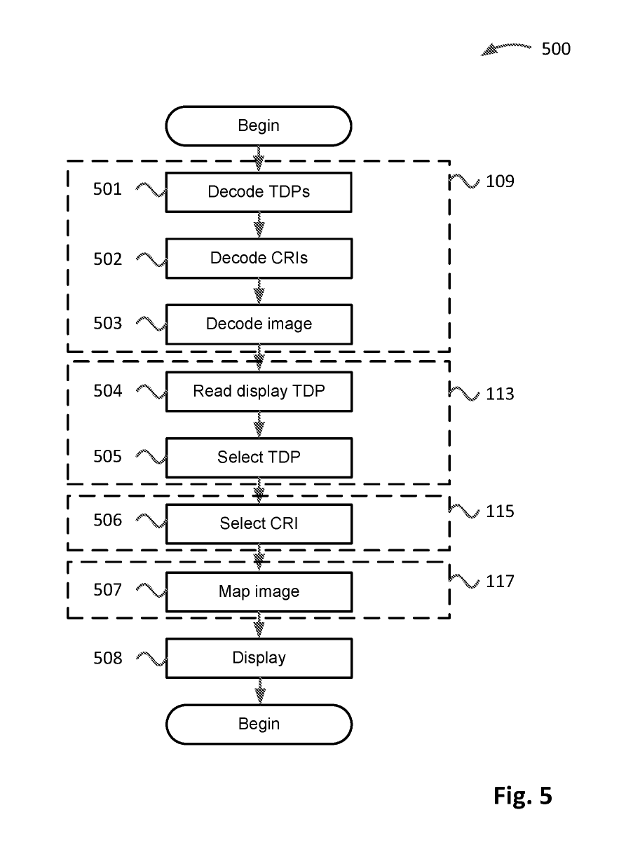

FIG. 5 is a schematic flowchart diagram showing a method 500 of displaying an image of video data on a display device such as the display device 214. The steps of the method 500 may be implemented by the modules 109, 113, 115 and 117 resident in the hard disk drive 210 and being controlled in their execution by the processor 205.

The method 500 starts with a decoding target device profiles (TDPs) step 501. At the decoding target device profiles (TDPs) step 501 the decoder 109, under control of the processor 205, decodes one or more target device profiles (TDP) 112 from the bitstream 108 containing the target device profiles (TDP) 112 and the video data to be displayed. As described above, each of the target device profiles (TDP) 112 contains device information comprising display luminance, contrast ratio and colour gamut of a target display device. The decoder 109 parses the bitstream 108, decoding syntax elements in accordance with the target device profile (TDP) structure 400 to extract the parameters of a given target device profile (TDP). Control in the processor 205 then passes to a decoding colour remapping information (CRI) structures step 502.

At the decoding colour remapping information (CRI) structures step 502, the decoder module 109, under control of the processor 205, decodes one or more colour remapping information (CRI) messages 111 from the bitstream 108. Control in the processor 205 then passes to a decoding image step 503.

At the decoding image step 503, an image of the video data 110 is decoded from the bitstream 108 under execution of the processor 205. The steps 501, 502 and 503 are performed by the decoding module 109 under execution of the processor 205. Control in the processor 205 then passes to a read display target device profile (TDP) step 504.

At the read display target device profile (TDP) step 504, the target device profile (TDP) 121 is read from the memory 206 under execution of the processor 205. The target device profile (TDP) 121 specifies display profile information of the display device 214. Control in the processor 205 then passes to a selecting target device profile (TDP) step 505.

At the selecting target device profile (TDP) step 505, the target device profile (TDP) message 121 is used under execution of the processor 205 to select a target device profile (TDP) message 114 from the decoded one or more target device profile (TDP) messages 112 as described below. The target device profile (TDP) message 114 is selected by comparing at least a portion of the device information of the device profile (TDP) messages 112 with corresponding device information of the display device 214.

The read display target device profile (TDP) step 504 and the selecting target device profile (TDP) step 505 are performed by the target device profile (TDP) selection module 113 under control of the processor 205. Control in the processor 205 then passes to a selecting colour remapping information (CRI) step 506.

At the selecting colour remapping information (CRI) step 506, the the target device profile (TDP) message 114 selected at step 505 is used, under execution of the processor 205, for selecting a colour remapping information (CRI) message 116 from the one or more colour remapping information (CRI) messages 111. As described above, each colour remapping information (CRI) message 111 defines an image modification parameter set including a colour gamut and dynamic range mapping providing information regarding luminance mapping. Selecting a colour remapping information (CRI) message 116 from the one or more colour remapping information (CRI) messages 111 according to the target device profile (TDP) message 114, results in selection of an image modification parameter set from one or more image modification parameter sets.

In one arrangement of the step 506, the processor 205 selects a colour remapping information (CRI) message 116 having a value of the colour_remap_id 301 equal to the value of the colour_remap_id 401 of the target device profile (TDP) 114 selected at step 505. The step 506 is performed by the colour remapping information (CRI) selection module 113, under control of the processor 205. Control in the processor 205 then passes to a map image step 507.

At the map image step 507, the mapping module 107, under control of the processor 205, maps samples of images of the decoded video data 110 to produce samples of images within the mapped video data 118, according to a mapping specified by the colour remapping information (CRI) message 116. As described above, the mapping forms an image modification parameter set.

The mapping module 107, under control of the processor 205 maps decoded images of the video data 110 onto images of the video data 118 by reading values of the samples of the decoded images of the video data 110, modifying the values as specified by the selected colour remapping information (CRI) message 116 and assigning the modified values to samples of images of the video data 118 (i.e., the modified values are assigned to at least a portion of the video data 118).

In another arrangement, the mapping module 107, under control of the processor 205, provides the mapping data 119 to the display device 214. The display device 214, under the control of the processor 205, performs a mapping of the video data 118 using the mapping data 119 prior to display at least a portion of the video data 118.

At displaying step 508, the display device 214, under control of the processor 205, displays the mapped video data 118 from the bitstream 108. In one arrangement of the display step 508, the processor 205 (e.g. which may be a processor within the display device 214) receives the mapping data 119 and applies the mapping data 119 to the samples of images of the decoded video data 110 to produce mapped video data 118 for display on the display device 214. As described above, the mapping to be applied at step 507 forms an image modification parameter set. The mapped video data 118 is displayed on the display device 214 by applying the image modification set to the portion of video data formed by the decoded video data 110. For example, at the select colour remapping information (CRI) step 506 the processor 205 selects a colour remapping information (CRI) message 116 that defines an image parameter set specifying modification of image colour gamut and luminance.

At the map image step 507, the mapping module 117, under the control of the processor 205, applies the colour gamut modification to the samples of images of the video data 118 and provides the mapping data 119 to the display device 214. The mapping data 119 in the example of FIG. 1 includes the luminance modification specified by the colour remapping information (CRI) message 116 and not applied to the mapped video 118 by the mapping module 117. At the display step 508, the display device 214 may be configured to modify the luminance of images of the video data 118 according to the mapping data 119 and to display the video data 118 on the display device 214.

In one arrangement of the select target device profile (TDP) step 505 of the method 500, the target device profile (TDP) selection module 113 under the control of the processor 205 selects from one or more of the target device profile (TDP) messages 112 a target device profile (TDP) message 114 that matches the target device profile (TDP) message 121 closely. To match the target device profile (TDP) message 121, each of the target device profile (TDP) messages 112 is compared to the target device profile (TDP) message 121 under execution of the processor 205. Then, a difference score for each of the target device profile (TDP) messages 112 is determined under execution of the processor 205 using Equation (6) below, and a target device profile (TDP) message having the smallest difference score is selected using Equation (7) below:

Sᵢ=A*Cᵢ+B*Lᵢ (6)

where Sᵢ is the difference score determined for the i-th target device profile (TDP) message from the target device profile (TDP) messages 112; Cᵢ and Lᵢ are difference scores of colour gamut and luminance range of the i-th message, determined as described below; and A and B are weight coefficients.

Index=argmin(Sᵢ), 0<i<=N (7)

where Index is the index of the target device profile (TDP) message 114 within the one or more target device profiles (TDP) 112; N is the total number of the target device profiles (TDP) in the one or more target device profiles (TDP) 112; Sᵢ is the difference score value for i-th target device profile (TDP); and argmin is a function returning an index value i of the smallest of its arguments Sᵢ.

The arrangement of Equation (6) allows target device profiles (TDP) to be compared in terms of differences their colour gamuts and luminance ranges. The arrangement of Equation (6) provides an efficient and computationally simple method of comparing the target device profiles (TDP). The weight coefficients A and B provides additional flexibility by allowing one aspect (e.g., colour gamut or luminance range) of a target device profiles (TDP) to be emphasized over the other.

In the select target device profile (TDP) step 505, the weight coefficients A and B may have the values of two (2) and one (1), respectively. In one alternative arrangement of the method 500, the weight coefficient A has value of zero (0) and thus the target device profiles (TDPs) are compared based only on luminance range difference. In another alternative arrangement of the method 500, the weight coefficient B has value of zero (0), and thus the target device profile (TDP) messages are compared based only on colour gamut difference.

In another arrangement of the method 500, the select target device profile (TDP) step 505 is modified such that a colour gamut difference score Cᵢ is determined under execution of the processor 205 as a weighted sum of differences between coordinates of colour primaries using Equation (8) as follows:

Cᵢ=W_{red}*D_{red}+W_{green}*D_{green}+W_{blue}*D_{blue} (8)

where Cᵢ is the colour gamut difference index; D_{red}, D_{green} and D_{blue} are Euclidean (L²) distances on the CIE 1931 xy chromaticity plane between the red, green and colour primaries 404 of the two target device profile (TDP) messages; and W_{red}, W_{green} and W_{blue} are distance weight coefficients. Example weight coefficients W_{red}, W_{green} and W_{blue} are values one (1), one (1) and zero point eight (0.8) respectively.

The arrangement of the Equation (8) allows colour gamuts to be compared in terms of differences between the colour primaries of the colour gamuts. Equation (8) provides an efficient and computationally simple way to compare colour gamuts.

Weight coefficients for each of the primaries may be used to account for sensitivity of the human visual system (HVS) to each of the primaries. For example, it is known that the human visual system (HVS) is less sensitive to changes in blue, compared to green or red. Therefore, it is advantageous to assign a smaller weight (W_{blue}) to the difference of the blue primaries (D_{blue}).

Arrangements of the method 500 allow a playback system including at least one of the following: the decoding module 109, the target device profile (TDP) selection module 113, the colour remapping information (CRI) selection module 115, the mapping module 117 and the display device 214 to perform video data remapping based on physical and colorimetric capabilities of the display device 214. In particular, where the capabilities of the display device 214 are less than, or substantially less than, the capability exploited by a particular video bitstream, the decoded video data is remapped in a controlled way (i.e. a way known to the creator of the video bitstream) into the smaller space afforded by the particular display device in use.

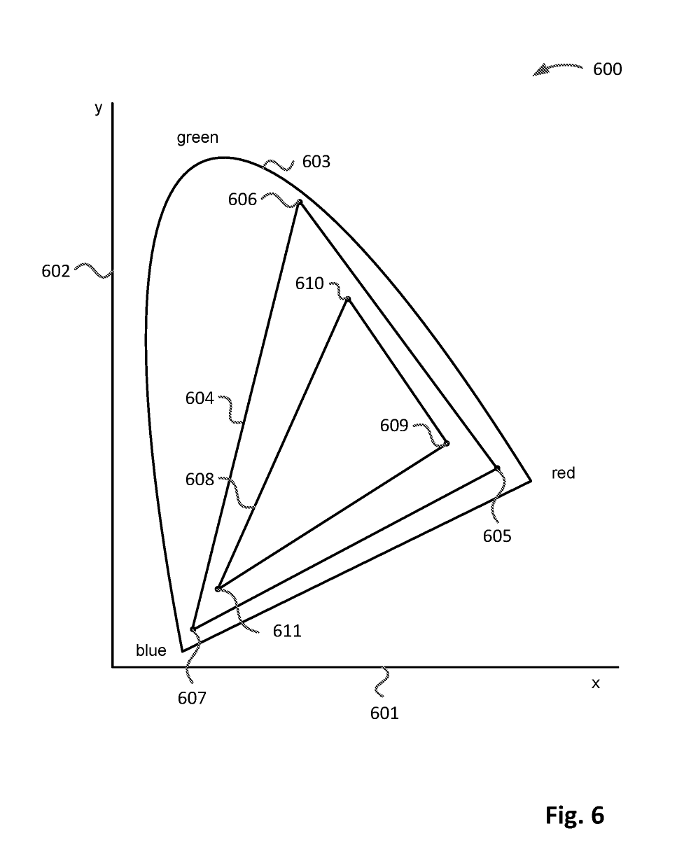

FIG. 6 is a schematic diagram showing the CIE 1931 xy chromaticity diagram 600 with an x axis 601, y axis 602, human-visible colour gamut 603 and two colour gamuts 604 and 608. The colour gamut 604 is represented by red, green and blue colour primaries 605, 606 and 607 correspondingly. The colour gamut 608 is represented by red, green and blue colour primaries 609, 610 and 611 correspondingly. Each of the colour gamuts 604 and 608 includes the colours with chromaticity coordinates within the triangles formed by the colour primaries. The colour gamut 608 is fully contained within the colour gamut 604. Both of the colour gamuts 604 and 608 are fully contained within the human-visible colour gamut 603.

In one arrangement of the select target device profile (TDP) step 505, the colour gamut difference score Cᵢ is determined to be one (1) if at least one of the colour primaries stored in the field 404 of the i-th target device profile (TDP) message from the one or more target device profile (TDP) messages 112 is located outside the triangle formed by the colour primaries stored in the field 404 of the target device profile (TDP) message 121. Otherwise, that is, if all the colour primaries of the field 404 of the i-th target device profile (TDP) message from the one or more target device profile (TDP) messages 112 are located within the triangle formed by the primary colour coordinates stored in the field 404 of the target device profile (TDP) message 121, the colour gamut difference score Cᵢ is determined to be zero (0). Referring to FIG. 6, if, for example, the i-th target device profile (TDP) message from the one or more target device profile (TDP) messages 112 has the colour gamut 608 and the target device profile (TDP) message 121 has that colour gamut 604, then the processor 205 determines Cᵢ to have a value of zero (0). If, for example, the i-th target device profile (TDP) message from the one or more target device profile (TDP) messages 112 has the colour gamut 604 and the target device profile (TDP) message 121 has the colour gamut 608, then the processor 205 determines the colour gamut difference score Cᵢ to have a value of one (1).

In another arrangement of the select target device profile (TDP) step 505, the luminance range difference Lᵢ is determined to be equal to a logarithm of the difference between the maximum luminance values of the two target device profiles (TDP) using Equation (9) as follows:

D=abs(L1ₘₐₓ−L²ₘₐₓ)

Lᵢ=log₁₀(D)−1, if D>10

Lᵢ=0, otherwise (9)

where Lᵢis the luminance difference score, L1ₘₐₓ and L2ₘₐₓ are maximum luminance values 403 of the two target device profile (TDP) messages and abs( ) is a function returning absolute value of its argument.

In the arrangement of the Equation (9), the luminance range difference Lᵢ is determined as a logarithm of the difference between the maximum luminance values L1ₘₐₓ and L2ₘₐₓ if the difference exceeds a threshold of ten (10) and zero (0) otherwise. The arrangement of the Equation (9) has an advantage of determining the difference Lᵢ in a way that approximates the human visual system (HVS) sensitivity to changes of luminance according to a well-known human visual system (HVS) model (the Weber-Fechner law). The arrangement of the Equation (9) also has an advantage of computational simplicity.

In another arrangement of the select target device profile (TDP) step 505, the luminance range difference Lᵢ is determined to be proportional to the ratio of the maximum luminance values of the two target device profiles (TDP) using Equation (10) as follows:

Lᵢ=abs(log₁₀(L1ₘₐₓ/L2ₘₐₓ)) (10)

where Lᵢ is the luminance difference score, L1ₘₐₓ and L2ₘₐₓ are maximum luminance values 403 of the two target device profile (TDP) messages and abs( ) is a function returning absolute value of its argument.

In the arrangement of the Equation (10), the luminance range difference Lᵢ is determined as an absolute value of the logarithm of the ratio between the maximum luminance values L1ₘₐₓ and L2ₘₐₓ.

The arrangement of the Equation (10) has an advantage of determining the difference Lᵢ in a way that approximates the human visual system (HVS) sensitivity to changes of luminance according to a well-known human visual system (HVS) model (the Weber-Fechner law).

In still another arrangement of the select target device profile (TDP) step 505, the selection of a target device profile (TDP) message from the one or more target device profile (TDP) messages 112 is performed under the control of a human operator.

In still another arrangement of the select target device profile (TDP) step 505, the processor 205 presents a list of target device profile (TDP) messages from the one or more target device profile (TDP) messages 112 on the display device 214 to a human operator and provides a means for the operator to select a target device profile (TDP) message.

In one arrangement of the video processing software architecture 100, the target device profile (TDP) message 121 includes information about ambient viewing conditions of the display device 214, such as ambient luminance or ambient white point.

In one arrangement of the video processing software architecture 100, the mapping module 117 receives one or more target device profile (TDP) messages 121, each of the target device profile (TDP) messages 121 corresponding to a display profile supported by the display device 214. Then, at the select target device profile (TDP) step 505, the processor 205 may select a target device profile (TDP) message 114 having the closest match among all the target device profile (TDP) messages 112 to a target device profile (TDP) message from the one or more target device profile (TDP) messages 121.

In one arrangement of the video processing software architecture 100, a target device profile (TDP) message 114 having the minimal difference score is selected using Equation (11) as follows:

$$P = {argmin}_{i} ( S ( i , j ) ) , 0 < i <= N , 0 < j <= M \qquad ( 11 )$$

where P is the index of the selected target device profile (TDP) message 114; S(i,j) is the difference score between i-th target device profile (TDP) message from the target device profile (TDP) messages 112 and j-th target device profile (TDP) message from the target device profile (TDP) messages 121; argmin is a function returning the value of the argument i for the smallest value of S(i, j) for all possible pairs of (i,j); N is the number of target device profile (TDP) messages 112; M is the number of target device profile (TDP) messages 121.

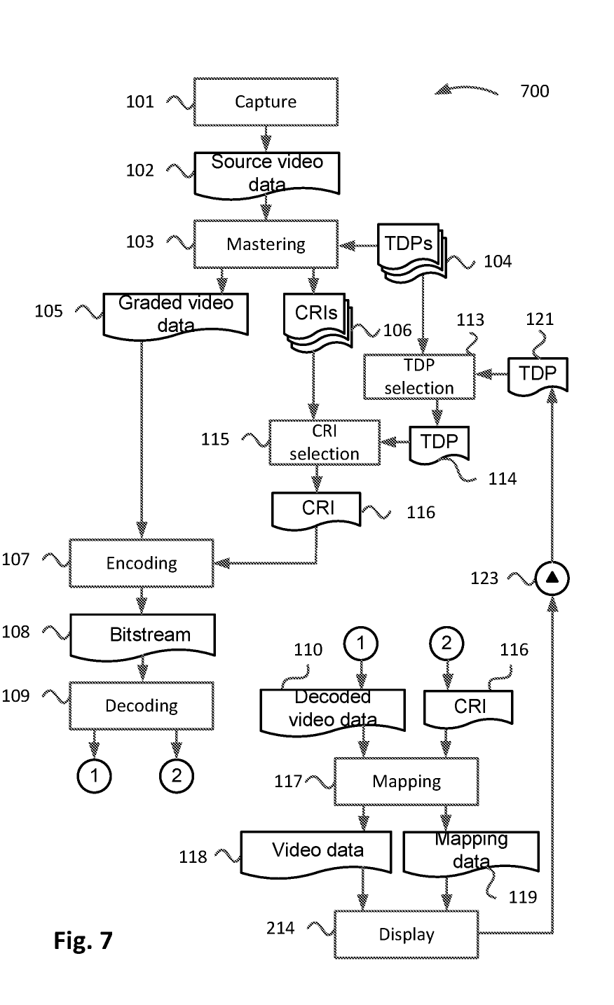

FIG. 7 shows a video processing architecture 700 that illustrates the software modules 101, 103, 107, 109, 113, 115 and 117 for capturing video data and displaying video data to a human viewer, according to another arrangement where the selection of the target device profile (TDP) 114 and colour remapping information (CRI) 116 is performed prior to encoding by the encoding module 107.

In the arrangement of FIG. 7, a real-time communication channel 123 is used to transmit device profile (TDP) message 121 of the display device 214 to the target device profile (TDP) selection module 113. The Internet Engineering Task Force (IETF) Real Time Streaming Protocol (RTSP) may be used for real-time video transmission for displaying on the display device 214.

In this arrangement of FIG. 7, the target display profile (TDP) message 121 is transmitted over the real-time communication channel 123 to the target device profile (TDP) selection module 113, for example, during the RTSP session establishment procedure.

In the arrangement of FIG. 7, the target device profile (TDP) selection module 113 selects a target device profile (TDP) message 114, as described above for the arrangements of FIG. 1. Similarly, the colour remapping information (CRI) selection module 115 selects a colour remapping information (CRI) message 116, as described above for the arrangements of FIG. 1. The colour remapping information (CRI) message 116 includes information to map the graded video data 105 for displaying on a display device having a device profile described by the target device profile (TDP) 121 such as the display device 214. The encoding module 107 encodes the graded video data 105 and the colour remapping information (CRI) message 116 into the bitstream 108. The decoding module 109 decodes the video data 110 and the colour remapping information (CRI) message 116 from the bitstream 108.

In the arrangement of FIG. 7, the mapping module 117 maps samples of images of the decoded video data 110 onto samples of images of the video data 118, as described above for the arrangements of FIG. 1. The display device 214 displays the video data 118.

As described above for the arrangements of FIG. 1, in the arrangement of FIG. 7, the mapping module 117 may provide a mapping data 119 to the display device 214 and display device 214 may use the mapping data 119 to map the video data 118 for displaying. For example, the decoding module 109 and the mapping module 117 may be integrated within the display device 214. The target device profile (TDP) selection module 113, the colour remapping information (CRI) selection module 115 and the encoding module 117 may be integrated within a remote video streaming server 290 connected to the network 220. The display device 214 may be connected to the remote video streaming server 290 using the Internet and the Real Time Streaming Protocol (RTSP). The display device 214 may send the target device profile (TDP) 121 to the target device profile (TDP) selection module 113 over the Internet. The remote video streaming server 290 then selects a colour remapping information (CRI) message 116 using the target device profile message 121 received from the display device 214 over the Internet. The remote video streaming server 290 then encodes the colour remapping information (CRI) message 116 into the bitstream 108.

In the example of FIG. 7, it is not necessary to encode any of the target device profile (TDP) messages 104 or colour remapping information (CRI) messages 106 into the bitstream 108. The decoding module 109 decodes a single colour remapping information (CRI) message 116 from the bitstream 108. The mapping module 117 uses the colour remapping information (CRI) message 116 to map the decoded video 110 into the video 118. The display device 214 displays the video 118.

In one arrangement of the video processing architecture 100, the target display profile (TDP) message 121 is transmitted from the display 214 to the target device profile (TDP) selection module 113 using the High-Definition Multimedia Interface (HDMI) protocol. In the arrangement where the target display profile (TDP) message 121 is transmitted from the display 214 to the target device profile (TDP) selection module 113 using the High-Definition Multimedia Interface (HDMI) protocol, the information of the target display profile (TDP) structure 400 is encapsulated within an ‘HDMI Consumer Electronics Control’ (HDMI CEC) protocol command. Advantageously, such arrangements allow the target device profile (TDP) selection module 113 in a video decoder (e.g. as present in a Blu-Ray disc player), to adapt the output signal to the display device 214 according to the capabilities of the particular display device 214 connected to the video decoder.

Arrangements of the video processing architecture 700 make the information about physical and colorimetric capabilities of the display device 214 available prior to encoding, or transmission over the communications channel, of the bitstream 108. Therefore, the video processing architecture 700 may perform colour remapping prior to encoding of the bitstream 108 for playback systems that do not support selection of colour remapping information (CRI) messages after decoding. In particular, it is only necessary to send the CRI message suitable for the target display 214 over the communications channel, as the TDP from the target display 214 was communicated back to the transmitter (or encoder). Thus, the required bandwidth for establishing a connection is reduced, as only the required TDP(s) are sent over the communications channel.

In an alternative arrangement of the video processing architecture 700 (not shown in FIG. 7) the colour remapping information (CRI) message 116 is applied to the graded video data 105 prior to encoding. In an arrangement where the colour remapping information (CRI) message 116 is applied to the graded video data 105 prior to encoding, it is not necessary to send the colour remapping information (CRI) message 116 to the decoding module 109, as the decoded video data 110 is already mapped according to the colour remapping information (CRI) message 116. The arrangement where the colour remapping information (CRI) message 116 is applied to the graded video data 105 prior to encoding is advantageous where the playback system doesn't support remapping of the video data 110 after decoding.

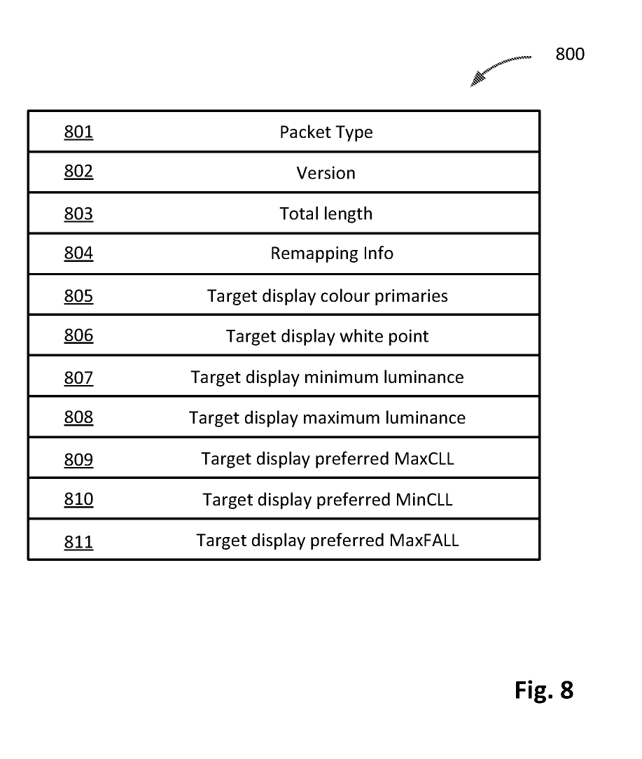

FIG. 8 is a schematic diagram showing a packet structure 800 of a HDMI CEC InfoFrame packet comprising display profile information that can be used to transmit display profile information of the structure 400 using the HDMI protocol. A packet type identifier 801 serves to distinguish an InfoFrame packet type from other HDMI CEC packet types. A numeric field 802 indicates the version of the display profile HDMI CEC packet. The numeric field 802 serves to distinguish between different standard layouts of the HDMI CEC display profile InfoFrame packet. A length field 803 specifies the length in bytes of an instance of the packet structure 800. A colour remapping information field 804 specifies colour remapping information.

In one arrangement of the packet structure 800, the colour remapping information field 804 comprises a packet identifier equivalent to the colour_remap_id field 401. The value of the colour remapping information field 804 may be used to identify another structure, similar to the structure 300 that includes the colour remapping information.

In one arrangement of the packet structure 800, the colour remapping information field 804 includes information of the pre-LUT set structure 302, matrix structure 303 and the post-LUT set structure 304 of the colour remapping information (CRI) structure 300.

In one arrangement of the packet structure 800, the colour remapping information field 804 includes colour volume transform information specified by the SMPTE ST.2094 standard.

A target display colour primaries field 805 includes information of the colour primaries field 404. A target display white point field 806 includes information of the white point field 405. A target display minimum luminance field 807 includes information of the minimum luminance field 402. A target display maximum luminance field 808 includes information of the maximum luminance field 403. A target display preferred MaxCLL field 809 includes information of the preferred MaxCLL field 406. A target display preferred MinCLL field 810 includes information of the preferred MinCLL field 407. A target display preferred MaxFALL field 811 includes information of the preferred MaxFALL field 408.

For example, the display device 214 may be connected to a playback device (not shown) such as a set top box or a DVD player with a HDMI connection. The decoding module 109, the target display profile (TDP) selection module 113, the colour remapping information (CRI) selection module 115 and the mapping module 117 may be integrated within the playback device. The playback device may be configured to receive the target device profile (TDP) message 121 from the display device 214 over the HDMI connection using the HDMI CEC InfoFrame packet 800. The playback device, under the control of the processor 205, applies the steps 501 through 507 to decode the bitstream 108 and map the decoded video 110 onto the video data 118. The playback device then transmits the video data 118 to the display device 214 using the HDMI connection. The display device 214 then displays the video data 118.

While a number of different arrangements are described above, many of the described arrangements may be used in combination with each other. Further, one or more of the arrangements may be combined to form a further arrangement.

### INDUSTRIAL APPLICABILITY

The arrangements described are applicable to the computer and data processing industries and particularly for the digital signal processing for the encoding and decoding of signals such as video signals.

The foregoing describes only some embodiments of the present invention, and modifications and/or changes can be made thereto without departing from the scope and spirit of the invention, the embodiments being illustrative and not restrictive.

Appendix A
Algorithm A.1

```
CalculateMaxCLL( )
{
  set MaxCLL = 0
  for each ( frame in the sequence ) {
    for each ( pixel in the active image area of the frame )
    {
      (R, G, B) = linearize(R′,G′,B′)
      set MaxCLL = max(R,G,B, MaxCLL)
    }
  }
  return MaxCLL
}
```

Appendix B
Algorithm B.1

```
CalculateMinCLL( )
{
  set MinCLL = 10000
  for each ( frame in the sequence ) {
    for each ( pixel in the active image area of the frame )
    {
      (R, G, B) = linearize(R′,G′,B′)
      set MinCLL = min(R,G,B, MinCLL)
    }
  }
  return MinCLL
}
```

Appendix C
Algorithm C.1

```
CalculateMaxFALL( )
{
  set MaxFALL = 0
  for each ( frame in the sequence )
  {
    set runningSum = 0
    for each ( pixel in the active image area of the frame )
    {
      (R, G, B) = linearize(R′, G′, B′)
      set maxRGB = max(R,G,B)
      set runningSum = runningSum + maxRGB
    }
    set frameAverageLightLevel =
      runningSum / numberOfPixelsInActiveImageArea
    if(frameAverageLightLevel>MaxFALL )
      set MaxFALL = frameAverageLightLevel
  }
  return MaxFALL
}
```

1. A method of displaying video data on a first display device, the method comprising:
decoding a plurality of display device profiles from a bitstream containing the video data, each of the plurality of display device profiles containing device information comprising display luminance, contrast ratio and colour gamut of a target display device;
selecting a display device profile from the decoded plurality of display device profiles by comparing at least a portion of the device information of the display device profiles with corresponding device information of the first display device;
selecting an image modification parameter set from a plurality of image modification parameter sets according to the selected display device profile, the plurality of image modification parameter sets being decoded from the bitstream and each of the plurality of image modification parameter sets providing information regarding luminance mapping to be applied to one or more portions of the video data from the bitstream of video data; and
displaying at least a portion of the video data on the first display device from the bitstream of video data by applying the selected image modification parameter set to the portion of video data from the bitstream of video data.

2. The method according to claim 1, further comprising comparing at least a portion of the device information of the display device profiles with corresponding device information of the first display device.

3. The method according to claim 1, further comprising determining a difference score for each of the display device profiles.

4. The method according to claim 1, wherein the selection of display device profile is performed under the control of a human operator.

5. The method according to claim 1, wherein each display device profile includes information about ambient viewing conditions of the display device.

6. The method according to claim 1, further comprising mastering the video data.

7. The method according to claim 1, wherein the image modification parameter sets are encoded into the bitstream as supplementary enhancement information messages.

8. The method according to claim 1, wherein the image modification parameter sets are encoded into the bitstream as video usability information messages.

9. The method according to claim 1, wherein at least one of display device profiles and image modification parameter set are conveyed in a side channel.

10. The method according to claim 1, wherein each image modification parameter set is stored within a structure including a lookup table.

11. The method according to claim 1, wherein each display profile is stored in a structure comprising a minimum and maximum luminance for the target display device.

12. An apparatus for displaying video data on a first display device, the apparatus comprising:
decoding module for decoding a plurality of display device profiles from a bitstream containing the video data, each of the plurality of display device profiles containing device information comprising display luminance, contrast ratio and colour gamut of a target display device;
display device profile selection module for selecting a display device profile from the decoded plurality of display device profiles by comparing at least a portion of the device information of the display device profiles with corresponding device information of the first display device;
modification parameter selection module for selecting an image modification parameter set from a plurality of image modification parameter sets according to the selected display device profile, the plurality of image modification parameter sets being decoded from the bitstream and each of the plurality of image modification parameter sets providing information regarding luminance mapping to be applied to one or more portions of the video data from the bitstream of video data; and
display module for displaying at least a portion of the video data on the first display device from the bitstream of video data by applying the selected image modification parameter set to the portion of video data from the bitstream of video data.

13. A system for displaying video data on a first display device, the system comprising:
a memory for storing data and a computer program;
a processor coupled to the memory for executing said computer program, said computer program comprising instructions for:
decoding a plurality of display device profiles from a bitstream containing the video data, each of the plurality of display device profiles containing device information comprising display luminance, contrast ratio and colour gamut of a target display device;
selecting a display device profile from the decoded plurality of display device profiles by comparing at least a portion of the device information of the display device profiles with corresponding device information of the first display device;
selecting an image modification parameter set from a plurality of image modification parameter sets according to the selected display device profile, the plurality of image modification parameter sets being decoded from the bitstream and each of the plurality of image modification parameter sets providing information regarding luminance mapping to be applied to one or more portions of the video data from the bitstream of video data; and
displaying at least a portion of the video data on the first display device from the bitstream of video data by applying the selected image modification parameter set to the portion of video data from the bitstream of video data.

14. A computer readable medium having a computer program stored thereon for displaying video data on a first display device, the program comprising:
code for decoding a plurality of display device profiles from a bitstream containing the video data, each of the plurality of display device profiles containing device information comprising display luminance, contrast ratio and colour gamut of a target display device;
code for selecting a display device profile from the decoded plurality of display device profiles by comparing at least a portion of the device information of the display device profiles with corresponding device information of the first display device;
code for selecting an image modification parameter set from a plurality of image modification parameter sets according to the selected display device profile, the plurality of image modification parameter sets being decoded from the bitstream and each of the plurality of image modification parameter sets providing information regarding luminance mapping to be applied to one or more portions of the video data from the bitstream of video data; and
code for displaying at least a portion of the video data on the first display device from the bitstream of video data by applying the selected image modification parameter set to the portion of video data from the bitstream of video data.
